(19) United States
(12) Patent Application Publication
(10) Pub. No.: US 2009/0028195 A1
(43) Pub. Date: Jan. 29, 2009

(54) SYSTEM AND METHOD FOR FREQUENCY CONVERSION OF COHERENT LIGHT

(75) Inventors: Yuri S. Grapov, Sutton, MA (US); Tatyana Chernysheva, Salt Lake City, UT (US); Allen H. Tanner, Sandy, UT (US)

Correspondence Address: THORPE NORTH & WESTERN, LLP., P.O. Box 1219, SANDY, UT, 84091-1219, US

(73) Assignee: EVANS & SUTHERLAND COMPUTER CORPORATION, Salt Lake City, UT (US)

(21) Appl. No.: 12/013,271

(22) Filed: Jan. 11, 2008

Related U.S. Application Data
(60) Provisional application No. 60/886,080, filed on Jan. 22, 2007.

(51) Int. Cl. H01S 3/10; H01S 3/04

(52) U.S. Cl. 372/22; 372/34

(57) ABSTRACT

A system and method is disclosed for converting a frequency of a coherent light source. A birefringent nonlinear material is cut at an angle for critical phase matching to form a rectangular parallelepiped biased nonlinear crystal. The nonlinear crystal cut at a biased angle can be placed at an angle in a coherent light beam to enable the beam to be directed through the crystal over a substantially optimal phase matching path while minimizing back reflection of the coherent light beam to the coherent light source.

### CROSS-REFERENCE TO RELATED APPLICATIONS AND CLAIM OF PRIORITY

Priority of U.S. Provisional patent application Ser. No. 60/886,080 filed on Jan. 22, 2007 is claimed.

### BACKGROUND

In many applications it is desirable to convert laser light of a given frequency to laser light of another frequency. Wavelength and frequency will be used interchangeably herein as applied to the laser light. For purposes of this disclosure, laser light will be appreciated as having a constant velocity in all relevant mediums. Thus defining the magnitude of one parameter defines the magnitude of the other. For example, in an enhancement cavity in a system where a laser pump system is being used to create a light output having a wavelength different from a light input, a non-linear crystal is conventionally used to convert from one frequency to another.

The efficiency of conversion in prior enhancement cavity systems can be relatively low. Moreover, thermal effects in the non-linear crystal and back-reflection into the laser source have required mitigation measures adding additional complexity, such as the use of high-powered optical isolators. The additional complexity has added to the overall cost of prior systems.

A variety of attempts have been made to design non-linear crystals that enable relatively high efficiency conversion of laser light from one frequency to another. For example, U.S. Pat. No. 5,943,350 to Shichijyo discloses an apparatus for high efficiency frequency conversion of laser light. Shichijyo discloses a non-linear crystal cut into a specific trapezoidal shape. The crystal is cut at a predetermined angle for a specific type of laser having a known frequency and power so that the incidence plane of the laser light entering the crystal is approximately an acceptance angle of the non-linear crystal to increase the efficiency of wavelength conversion. However, once the crystal has been cut into the trapezoidal shape, variations in the crystal and/or its operating environment can reduce frequency conversion efficiency. For example, small differences in the shape and cutting angle of the crystal from the optimal shape, changes in temperature at the crystal, variation in the angle of incidence between the crystal and the laser, deviation of the frequency of the laser, and so forth can reduce the overall efficiency of frequency conversion. These changes typically cannot be compensated for once the crystal has been cut to a predetermined trapezoidal shape.

U.S. Pat. No. 5,982,805 to Kaneda discloses the use of a non-linear optical crystal element placed inside an optical resonator. The crystal is placed at a tilted angle relative to the laser beam to reduce an amount of light that is reflected from the crystal back to the laser light source. A fine adjust control is used to reduce back reflection and for adjusting the tilt of the non-linear optical crystal for phase-matching to increase efficiency. This enables non-critical phase matching to occur, wherein a fundamental laser light frequency and a harmonic laser light frequency propagate along the optical axis.

### SUMMARY

A system and method is disclosed for converting a frequency of a coherent light source. A birefringent nonlinear crystal in a shape of a rectangular parallelepiped is cut for critical phase matching for a selected temperature. This cut is at a biased angle Δφ with respect to the theoretically calculated angle φth for the selected temperature. This nonlinear crystal can then be placed at an angle with respect to the optical beam path (optical axis of the cavity) in the cavity in a coherent light beam to enable the beam to be directed through the crystal. The beam is directed through the crystal over a substantially optimal phase matching path while minimizing back reflection of the coherent light beam to the coherent light source.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is an illustration of a frequency conversion block cut at a biased angle from a material in accordance with an embodiment of the present invention;

FIG. 2a is a top view block diagram of a system for frequency conversion of coherent light in accordance with an embodiment of the present invention;

FIG. 2b is a side view block diagram of a system for frequency conversion of coherent light in accordance with an embodiment of the present invention;

FIG. 3 is graph comparing input power in watts at a first frequency to output power at a doubled frequency using the frequency conversion block in accordance with an embodiment of the present invention;

FIG. 4 is a graph showing conversion efficiency of the power in versus the power out of FIG. 3 in accordance with an embodiment of the present invention; and

FIG. 5 is a flow chart depicting a method for increasing a frequency of coherent light in accordance with an embodiment of the present invention.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

Crystal materials lacking inversion symmetry can exhibit a so-called χ⁽²⁾ nonlinearity. This nonlinearity can give rise to the phenomenon of frequency doubling. Frequency doubling can occur when a laser input (pump) provides coherent electromagnetic waves input into a crystal medium at a first frequency that generates electromagnetic waves that have twice the frequency within the medium. This process is also called second-harmonic generation.

For low pump intensities, the second-harmonic conversion efficiency is small. The conversion efficiency grows nonlinearly with increasing pump intensity so that the second-harmonic (frequency-doubled) wave grows with the square of the pump intensity:

P₂=γP₁²

where P₂ is the power of the second-harmonic wave relative to the pump intensity P₁.

Frequency doubling is often carried out by placing a crystal having predetermined characteristics in the path of a laser beam at a specifically-chosen angle. Commonly used crystals are BBO (β-barium borate), KDP (potassium dihydrophosphate), and LBO (lithium niobate). These crystals have the desired properties of being strongly birefringent, having specific crystal symmetry, and being substantially transparent over a desired frequency range of laser light. The crystals can also withstand heating from the laser light due to non-efficiencies in frequency doubling. Other types of crystals having highly non-linear properties, such as being periodically poled, can also be used for frequency doubling of laser light.

The efficiency of second harmonic generation using low power lasers can be increased by placing the crystal within the enhancement cavity of a laser, where the pump intensity is typically an order of magnitude greater than outside the cavity. Efficiency can also be increased by using a pulsed pump source, rather than a continuous wave laser source. Since the amount of power produced by a laser is inversely proportional to the amount of time the laser was on, a large amount of power can be sent over a very short period. Thus, a pulsed laser can be used to increase the power of the pump source, thereby increasing the efficiency of the second harmonic generation.

Frequency doubling is a phase-sensitive process which typically involves phase matching between the input waves and the second-harmonic waves to be efficient. In a typical situation, the electric fields are traveling waves described by:

Eⱼ(x,t)=e^{i(ω}^{ⱼ}^{t-k}^{ⱼ}^{·x)},

at position x, with the wave vector kⱼ=n(ωⱼ)ωⱼ/c, where c is the velocity of light and n(ωⱼ) is the index of refraction of the crystal medium at angular frequency ωⱼ. The second-order polarization angular frequency ω₃ is:

P⁽²⁾(x,t)∝E₁ⁿ^{₁}E₂ⁿ^{₂}e^{i(ω}^{₃}^{t-(m}^{₁}^{k}^{₁}^{+m}^{₂}^{k}^{₂}^{)·x)}.

At each position x, the oscillating second-order polarization radiates at angular frequency ω₃ providing a corresponding wave vector k₃=n(ω₃)ω₃/c. Constructive interference can enable a high intensity ω₃ field to occur at positions where:

k₃=m₁k₁+m₂k₂.

Crystals are typically cut to enable the desired wave to exit the crystal at a point where an input wave at f₁ and an output wave at f₂ are in phase, as shown by the equation above, allowing for constructive interference to maximize the power of the output wave at f₂.

One factor which can negatively affect the conversion efficiency is the heat generated within the crystal by the laser pump source. The overall power entering the crystal is typically measured in watts/cm². Heating the crystal can alter the crystalline structure which can change the phase of the input and output waves respectively. The change in the crystalline structure can change the phase of the input wave f₁ and output wave f₂ in such a way that the phase difference alternately increases and decreases over a change in temperature of the crystal.

A crystal is typically cut to operate at a predetermined temperature for critical phase matching. That temperature is usually above an ambient temperature in which the crystal is operated. The selected operating temperature of the crystal is typically kept above ambient temperature in order to reduce the shock gradient from heat introduced to the crystal from the pump laser. At lower temperatures the shock gradient with respect to time can be quite steep. Depending on the severity of the shock gradient, the crystal can be damaged or require a certain amount of time to relax to a point where the crystalline structure is properly aligned to produce the desired results. In the case of a pulsed laser, any thermally induced shock gradient should be kept to a minimum to allow the laser to operate over a substantial period of the entire pulse. Thus, a crystal is typically designed and cut to operate at a temperature above ambient temperature. A variety of types of heating devices, such as a Peltier thermoelectric device, can be used to maintain a crystal's temperature at a predetermined level, as can be appreciated.

An additional factor which can affect conversion efficiency is back-reflection of laser light to the laser pump source. When a frequency doubling crystal is placed within a laser cavity, a certain amount of light is reflected from the crystal, back into the laser pump source. As the amount of laser power within the laser cavity is increased, the amount of back-reflected light can negatively affect the efficiency of the laser. Too much laser light re-entering the pump laser source can cause the pump to burn up or otherwise shut down. Thus, it is imperative that back-reflection of laser light from the crystal into the laser pump source is minimized.

Reducing back-reflection of laser light from the crystal is typically done by adjusting the angle of the crystal relative to the pump source. One or more faces of the crystal can contribute to back-reflection, depending on the shape of the crystal. The crystal is typically adjusted such that the angle of reflection from the crystal face(s) is directed away from the pump source. However, adjusting the arrangement of the crystal to minimize back-reflection can negatively affect the desired path selected for maximizing conversion efficiency. Thus, the desired results of minimizing back-reflection while maximizing conversion efficiency can be adverse to one another.

In accordance with one embodiment of the invention, it has been recognized that a system and method is needed to maximize frequency conversion efficiency of coherent light while minimizing back-reflection of the coherent light from a non-linear crystal into a laser pump source.

A non-linear crystal typically used in converting a frequency of coherent light is a birefringent crystal. While the term birefringent crystal is used throughout the specification, it is possible that other types of birefringent material can also be used. Birefringent material, such as a birefringent crystal, is a material having anisotropic properties that enable the decomposition of a light ray into two rays, an ordinary ray and an extraordinary ray. Such a material is typically referred to as having a single axis of anisotropy, or uniaxial. The two rays, having wavelengths λ₁ and λ₂, can have two different indexes of refraction, n₀ and nₑ, causing the waves to travel at different speeds through the material. The non-linear effects of the material can provide second harmonic generation (SHG), or frequency doubling of the laser light when the two rays have substantially equal wavelengths. Alternatively, when the wavelengths are not equal, frequency mixing can occur within the birefringent material, as can be appreciated.

In order for frequency doubling to take place in a second harmonic generation crystal, the refractive index of the input laser light should equal the refractive index of the frequency-doubled light to be produced. The refractive index of a crystal is a function of both the incidence angle and frequency of the input beam. Thus, the input angle is dependent on the frequency of the input beam. The input angle at which frequency doubling is most efficient will be referred to hereinafter as the phase matching angle. The path at which the laser light travels through the crystal, when entering the crystal at a substantially optimal phase matching angle, is referred to as the phase matching path. The phase matching path can be theoretically calculated for a specific type of birefringent material at a predetermined temperature for a laser configured to output coherent light at a specific frequency.

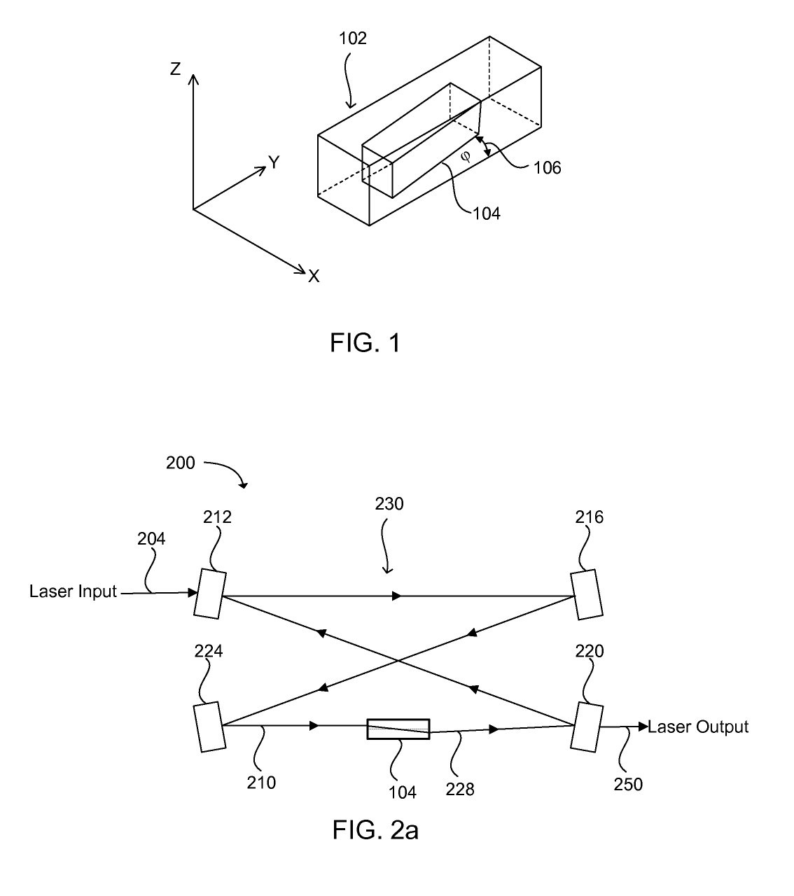

As illustrated in FIG. 1, a birefringent nonlinear material 102 is shown having a crystallographic axis comprising three non-coplanar axes in the x, y, and z directions that are substantially parallel to the edges of the material 102. Birefringent nonlinear material, such as a crystal, can be cut for critical phase matching such that substantially optimal phase matching is achieved when the phase matching beam path is perpendicular to one of the faces of a rectangular parallelepiped shaped crystal. Critical phase matching is achieved in the principal plane xy by varying azimuthal angle φ. However, when the phase matching path is perpendicular to one of the faces it may cause back-reflection from the faces of the material into a laser pump. Back-reflection into a laser pump can substantially affect the performance and degrade the life of the laser pump.

Previous attempts to avoid back-reflection into the laser pump include cutting the crystal in a trapezoidal parallelepiped shape. However, the trapezoidal parallelepiped shape is a more complex shape to cut, polish and coat than a rectangular parallelepiped. Additionally, once a crystal has been cut into a trapezoidal parallelepiped, the crystal is substantially fixed to be used with the predetermined phase matching path for which the crystal was cut. Should any of the parameters change, such as temperature or frequency, a new trapezoidal parallelepiped crystal would typically need to be cut.

To alleviate the adverse relationship between the optimal phase matching path and the need to reduce back-reflection while maintaining a simple geometry that is relatively uncomplicated to cut, polish, and coat, it has been discovered that the material 102 can be cut at an angle relative to the crystallographic axis of the material to produce a frequency conversion block 104 having an induced bias angle Δφ. The frequency conversion block can be cut to form a rectangular parallelepiped shape. The optimal phase matching path can be designed into the frequency conversion block by selecting the temperature the crystal will be maintained at and the amount of angle of the induced bias of the nonlinear material in the frequency conversion block caused by the angle at which the block 104 was cut from the material 102.

The optimal phase matching path of the frequency conversion block can be selected to allow the block 104 to be adjusted to minimize back reflection of the laser light from the block into the laser pump. For example, the frequency conversion block 104 can be cut from the birefringent nonlinear material 102 at an angle φ 106 of 10.4 degrees relative to the crystallographic axis of the material for a selected temperature. The optimal phase matching angle φth to achieve substantially maximum frequency conversion efficiency may be 11.4 degrees with respect to the optical axis for the same temperature. Thus, in this example, the frequency conversion block is cut with a bias angle Δφ=φ−φth of 1 degree relative to the optimal phase matching angle.

Cutting the frequency conversion block at an angle greater than or less than the theoretically calculated optimal phase matching path can provide an induced bias allows the block to be placed in a photonic stream at an angle that will provide a substantially optimal phase matching path while reflecting or refracting a substantially minimum amount of power in back reflection to the laser source. Back reflection can be minimized since the first plane of the block that is cut at a biased angle can be positioned to be non-perpendicular with the laser source while still allowing the coherent light beam to travel through the block along the optimal phase matching path.

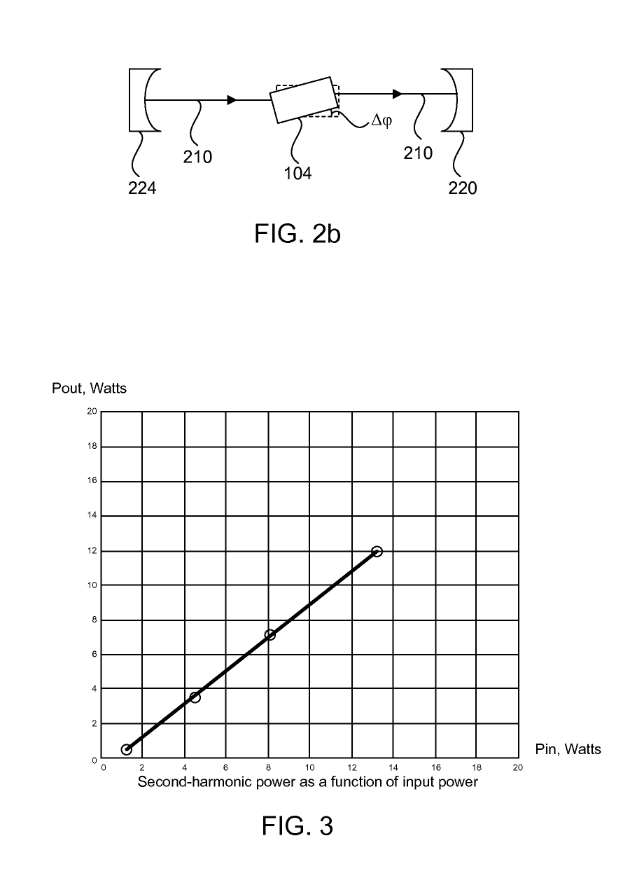

As illustrated in FIG. 2a, a resonance laser pumping system 200, in an example implementation in accordance with the invention is shown. The laser pumping system is shown in a “bow tie” configuration that includes a laser beam input 204. The laser beam input 204 can be from a laser pump or another type of coherent optical source. The laser beam can be directed between lens elements 212, 216, 220, and 224. The photonic stream under consideration begins at the photonic input 210 as light at a first frequency, and ends at the photonic output 228 as light at a second frequency.

One of the lens elements 212 provides a partially transmissive mirror device configured to pass a first portion of laser light from the laser input into an enhancement area 230 between the mirrors. A second portion of laser light will be reflected light once it has passed into the enhancement portion and passed through the frequency conversion block 104 interposed in the photonic stream in a manner as previously discussed. One of the mirrors, 220, can be a dichroic mirror configured to allow certain frequencies to pass, while reflecting other frequencies. For example, laser light that has been converted to a second frequency will pass through the mirror 220 to the laser output, while light that has not been converted will be reflected and substantially remain within the cavity until it has been converted to the second frequency. In one embodiment, the photonic input 210 may have a wavelength λ of 1064 nanometers (nm). The laser output will have a wavelength λ of 512 nm. Of course, the present invention can be used at any frequency at which light is converted from one frequency to another using a non-linear crystal.

Unlike a trapezoidal shaped crystal having a fixed shape for a predetermined set of requirements, forming the frequency conversion block 104 as a rectangular parallelepiped typically allows variations in initial conditions. Various means can be used to tune the frequency conversion block to maximize its frequency conversion efficiency, as can be appreciated. For example, a frequency of the coherent light source can be adjusted, a temperature of the frequency conversion block can be changed, and an angle of the block with respect to the photonic stream can be fine tuned to increase conversion efficiency while minimizing any back-reflection of the photonic stream.

The induced biased angle of the birefringent nonlinear material in the block 104 can enable the block to be positioned at an angle that can minimize back-reflection while achieving an optimal phase matching path to maximize frequency conversion efficiency. The block can also be coated with a material to reduce reflected light from the surfaces of the block. It should be noted that the block has to be adjusted in the principal plane to achieve the optimal phase matching path, as can be appreciated.

FIG. 2b illustrates the system of FIG. 2a from a side view. The frequency conversion block 104 can be placed at a biased angle Δφ with respect to the photonic input 210. The biased angle can be approximately the same biased angle at which the frequency conversion block was cut, thereby enabling the photonic input to travel through the frequency conversion block at the optimal phase matching path while minimizing reflection back to the laser source. The angle of the frequency conversion block can be adjusted to achieve a maximum output power. The ability to adjust the position of the frequency conversion block 104 to minimize back-reflection while still directing the laser light along the optimal phase matching path provides a substantial increase in efficiency and the longevity of the laser compared with prior frequency doubling systems.

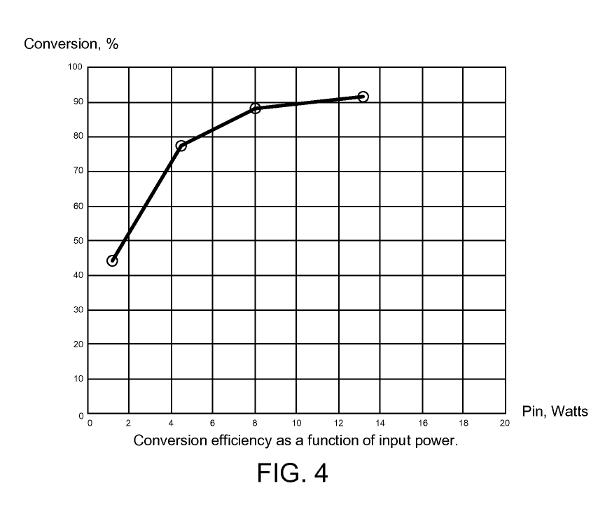

FIG. 3 shows results measured for one embodiment of the system, wherein laser light from an infrared laser (λ=1064 nm) is frequency doubled to produce a green laser (λ=532 nm) output. It can be seen that as the power in (Pᵢₙ) increases, the efficiency of the system enables a substantial amount of power out (Pₒᵤₜ). FIG. 4 shows the efficiency of the power out versus power in from FIG. 3. The efficiency is calculated based on Pₒᵤₜ/Pᵢₙ, where Pᵢₙ is the input fundamental power and Pₒᵤₜ is the total generated harmonic power.

It can be seen from FIG. 4 that there is over 90% efficiency in the frequency conversion process as the input power of the infrared laser to the frequency conversion block increases above 12 watts. An efficiency of 80% at approximately 10 watts of input power is considered to be extraordinary in the field of frequency conversion of laser light. The present system and method are not limited to 90% efficiency. Systems that enable efficiencies of greater than 90% efficiency or greater are possible.

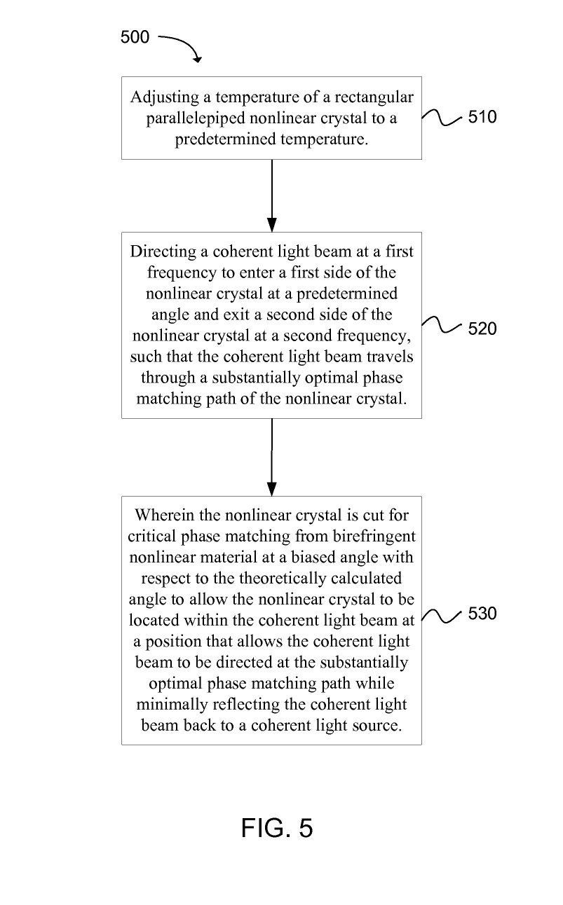

In another embodiment, a method 500 for increasing a frequency of coherent light is disclosed, as illustrated in the flow chart of FIG. 5. The method includes the operation of adjusting 510 a temperature of a rectangular parallelepiped nonlinear crystal to a predetermined temperature. The selected operating temperature of the crystal is typically kept above ambient temperature in order to reduce the shock gradient from heat introduced to the crystal from the pump laser. As previously discussed, a variety of types of heating devices, such as a Peltier thermoelectric device, can be used to maintain a crystal's temperature at a predetermined level. Any type of temperature control device capable of keeping the crystal within a desired temperature range is considered to be within the scope of the invention.

The method 500 includes the further operation of directing 520 a coherent light beam at a first frequency to enter a first side of the nonlinear crystal at a predetermined angle and exit a second side of the nonlinear crystal at a second frequency. The coherent light beam is directed through the crystal such that the coherent light beam travels through a substantially optimal phase matching path of the nonlinear crystal. The nonlinear crystal is cut for critical phase matching 530 from birefringent nonlinear material at a biased angle with respect to the theoretically calculated angle to allow the nonlinear crystal to be located within the coherent light beam at a position that allows the coherent light beam to be directed at the substantially optimal phase matching path while minimally reflecting the coherent light beam back to a coherent light source.

Creating a frequency conversion block for critical phase matching with an induced bias can substantially increase the efficiency of frequency conversion and significantly lengthen the life of a laser by minimizing back reflection into a laser pump. The decreased amount of back reflection can also reduce complexity and cost of a laser system by eliminating the need for additional means that are typically used to decrease back reflection.

The examples above are directed to frequency doubling using second harmonic generation in a birefringent non-linear material. However, cutting birefringent non-linear material with an induced bias relative to a theoretically calculated cut angle for critical phase matching at a predetermined temperature of the birefringent material can also be used for frequency tripling and frequency mixing, as can be appreciated.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A system for converting a frequency of coherent light, comprising:
a coherent light source configured to produce a first coherent light beam at a first frequency;
a rectangular parallelepiped nonlinear crystal cut from birefringent material at a biased angle with respect to a theoretically calculated cut angle for critical phase matching at a predetermined temperature of the birefringent material to enable the crystal cut at the biased angle to be positioned at an angle within a path of the coherent light beam to provide a substantially optimal phase matching path while substantially minimizing back reflection from the crystal to the coherent light source, wherein the nonlinear crystal is configured to output a second coherent light beam at a second frequency;
a temperature adjusting device configured to adjust a temperature of the nonlinear crystal to a predetermined temperature to increase an efficiency of converting the frequency of the coherent light.

2. A system as in claim 1, further comprising a temperature adjusting device configured to adjust a temperature of the nonlinear crystal to a predetermined temperature to increase an efficiency of converting the frequency of the coherent light.

3. A system as in claim 1, further comprising a feedback device configured to redirect at least a portion of the coherent light source exiting the second side of the non-linear crystal into the first side of the non-linear crystal.

4. A system as in claim 3, wherein the portion of the coherent light source that is redirected is coherent light that is less than the second frequency.

5. A system as in claim 3, wherein the feedback device further comprises a dichroic mirror configured to reflect coherent light at the first frequency while passing coherent light at the second frequency.

6. A system as in claim 1, wherein the second frequency is a harmonic of the first frequency.

7. A system as in claim 1, wherein the second frequency is a second harmonic of the first frequency.

8. A system as in claim 1, wherein the second frequency is a third harmonic of the first frequency.

9. A system as in claim 1, wherein the first frequency mixed with a third frequency such that the second frequency is equivalent to the first frequency plus the third frequency.

10. A method for increasing a frequency of coherent light, comprising
adjusting a temperature of a rectangular parallelepiped nonlinear crystal to a predetermined temperature;
directing a coherent light beam at a first frequency to enter a first side of the nonlinear crystal at a predetermined angle and exit a second side of the nonlinear crystal at a second frequency, such that the coherent light beam travels through a substantially optimal phase matching path of the nonlinear crystal;
wherein the nonlinear crystal is cut for critical phase matching from birefringent nonlinear material at a biased angle with respect to a theoretically calculated optimal phase matching path to allow the nonlinear crystal to be located within the coherent light beam at a position that allows the coherent light beam to be directed through the nonlinear crystal at the substantially optimal phase matching path while minimally reflecting the coherent light beam back to a coherent light source.

11. A method as in claim 10, further comprising adjusting an angle of the nonlinear crystal with respect to the coherent light beam to provide a substantially maximum power output of the coherent light beam output from the crystal relative to the power of the coherent light beam entering the first side of the crystal.

12. A method as in claim 11, further comprising adjusting the angle of the nonlinear crystal with respect to the coherent light beam to compensate for changes in one of the first frequency of the coherent light beam and the temperature of the non-linear crystal.

13. A method as in example 10, further comprising guiding at least a portion of the coherent light beam from the second side of the nonlinear crystal to reenter the first side of the non-linear crystal at the predetermined angle.

14. A method of making a system for converting a frequency of coherent light, comprising:
cutting a rectangular parallelepiped nonlinear crystal from birefringent nonlinear material at a biased angle relative to a theoretically calculated optimum angle for critical phase matching at a selected temperature; and
placing the non-linear crystal cut at a biased angle in a path of a coherent light beam at a predetermined angle to enable a coherent light beam to pass through the crystal over a substantially optimal phase matching path while minimizing back-reflection of the coherent light beam from the nonlinear crystal to a coherent light source.

15. A method of making as in claim 14, further comprising thermally coupling a temperature control device to the nonlinear crystal to enable a temperature of the nonlinear crystal to be substantially maintained at a predetermined temperature.

16. A method of making as in claim 14, further comprising placing the non-linear crystal with a plurality of lens elements configured in a bow tie configuration.

17. A method of making as in claim 16, further comprising directing the coherent beam of light between the plurality of lens elements such that the coherent light beam output from the crystal having a frequency equal to the coherent light beam input to the crystal is redirected to be input into the crystal.

18. A method of making as in claim 16, further comprising removing a portion of the coherent light beam from the bow tie configuration that has a frequency greater than a frequency of the coherent light beam input into the crystal.

19. A method of making as in claim 18, wherein one of the mirrors is a dichroic mirror configured to pass coherent light having a frequency greater than the frequency of the coherent light beam input into the crystal.
